(19) United States
(12) Patent Application Publication
(10) Pub. No.: US 2002/0095434 A1
(43) Pub. Date: Jul. 18, 2002

(54) Performance modeling based upon empirical measurements of synchronization points

(76) Inventor: Robert M. Lane, Dixon, CA (US)

Correspondence Address: PARK, VAUGHAN & FLEMING LLP, 508 SECOND STREET, SUITE 201, DAVIS, CA, 95616, US

(21) Appl. No.: 09/760,137

(22) Filed: Jan. 12, 2001

(51) Int. Cl. G06F 12/00

(52) U.S. Cl. 707/201

(57) ABSTRACT

One embodiment of the present invention provides a system that uses empirical measurements of accesses to synchronization points within an application to construct a performance model for the application. This system operates by modifying the application to record statistics related to the synchronization points within the application. The system then runs the application to produce the statistics related to the synchronization points. Next, the system constructs the performance model based upon the statistics, and then uses the performance model to predict a performance of the application. Through use of such a performance model, bottlenecks can be identified and strategies to alleviate the bottlenecks can be devised. Furthermore, experiments can be performed on the model in order to select an optimum strategy for implementation.

### BACKGROUND

1. Field of the Invention

The present invention relates to inter-process synchronization mechanisms in computer systems. More specifically, the present invention relates to a method and apparatus for using empirical measurements of synchronization points within an application to construct a performance model for the application.

2. Related Art

Modern computer systems often support multi-threaded applications in which multiple threads and/or processes operate concurrently. In order to work together, these multiple threads and/or processes must somehow coordinate their accesses to these shared resources. Otherwise, processes may conflict with each other during accesses to the shared resources. For example, if the shared resource is a buffer pool from which processes allocate memory, accesses to the buffer pool are typically serialized to prevent two processes from allocating the same block of memory.

Computer systems typically use a mutual exclusion variable to serialize access to a shared resource or a critical section of code. Before a thread accesses a shared resource, it first attempts to acquire a mutual exclusion variable associated with the shared resource. If the thread successfully acquires the mutual exclusion variable, it accesses the shared resource. If the thread is unable to acquire the mutual exclusion variable, it blocks on the variable until the mutual exclusion variable is relinquished by a thread that holds the mutual exclusion variable. After the thread is finished with the shared resource, it releases the mutual exclusion variable associated with the shared resource so that other threads may access the shared resource. In this way, accesses to the shared resource can be serialized.

Unfortunately, threads are often blocked while waiting for a mutual exclusion variable, and this can greatly reduce overall system performance. This performance problem can be mitigated in a number of ways, for example by splitting a single mutual exclusion variable into multiple mutual exclusion variables. However, in order to do so, it is first necessary to determine which mutual exclusion variables or other synchronization points create the main bottlenecks to overall system performance.

A model, such as a queuing theory model, can be used to predict system performance. However, the assumptions made in constructing the model are often highly inaccurate, which can lead to highly inaccurate performance predictions.

What is needed is a method and apparatus for accurately modeling the behavior of a multi-threaded computers system that uses mutual exclusion variables to restrict access to shared resources.

### SUMMARY

One embodiment of the present invention provides a system that uses empirical measurements of accesses to synchronization points within an application to construct a performance model for the application. This system operates by modifying the application to record statistics related to the synchronization points within the application. The system then runs the application to produce the statistics related to the synchronization points. Next, the system constructs the performance model based upon the statistics, and then uses the performance model to predict a performance of the application. Through use of such a performance model, bottlenecks can be identified and strategies to alleviate the bottlenecks can be devised. Furthermore, experiments can be performed on the model in order to select an optimum strategy for implementation.

In one embodiment of the present invention, constructing the performance model based upon the statistics involves constructing an analytic model for the application. In this embodiment, using the performance model to predict the performance involves numerically solving the analytic model to predict the performance for the application.

In one embodiment of the present invention, constructing the performance model based upon the statistics involves constructing a simulation model for the application. In this embodiment, using the performance model to predict the performance involves running the simulation model to predict the performance for the application.

In one embodiment of the present invention, modifying the application involves compiling the application with a profiling option in order to record the statistics related to synchronization points.

In one embodiment of the present invention, modifying the application involves modifying the executable code of the application to record the statistics during system calls that operate on the synchronization points.

In one embodiment of the present invention, the statistics include, an identifier for a calling function, an identifier for a mutual exclusion variable, a time spent holding the mutual exclusion variable, and a frequency of accesses to the mutual exclusion variable.

In one embodiment of the present invention, the statistics include a directed call graph specifying an ordering of function calls.

In one embodiment of the present invention, constructing the performance model involves constructing a queuing model wherein each synchronization point is a service center for jobs representing processes that circulate between service centers in a manner specified by the directed call graph.

### BRIEF DESCRIPTION OF THE FIGURES

FIG. 1 illustrates a computer system in accordance with an embodiment of the present invention.

FIG. 2 is a flow chart illustrating the modeling process in accordance with an embodiment of the present invention.

FIG. 3 illustrates how an interposition library operates in accordance with an embodiment of the present invention.

FIG. 4 illustrates a performance model in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

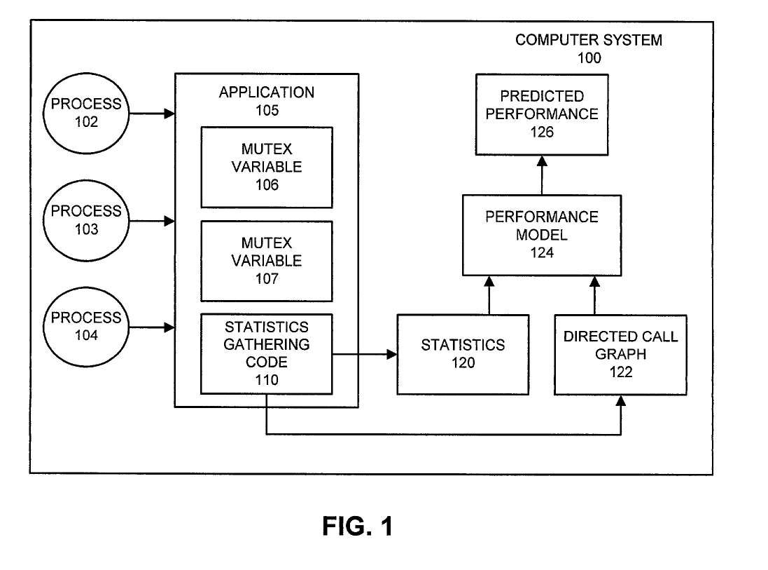

FIG. 1 illustrates a computer system 100 in accordance with an embodiment of the present invention. Computer system 100 can generally include any type of computer system that is able to support multiple threads and/or processes, including, but not limited to, a computer system based on a microprocessor, a mainframe computer, a digital signal processor, a portable computing device, a personal organizer, a device controller, and a computational engine within an appliance.

Computer system 100 supports a number of processes 102-104. Processes 102-104 can include different threads of execution that operate in the same address space. Alternatively, processes 102-104 can include different processes that operate in different addresses spaces, but can access the same mutual exclusion variables through shared memory.

Processes 102-104 concurrently execute application 105. Application 105 can generally include any type of multi-threaded application, such as an operating system, a database application or multi-threaded equation solver. Application 105 manipulates a number of mutual exclusion variables 106-107, which are used to serialize access to a shared resource. Mutual exclusion variables 106-107 can generally include a mutual exclusion variable associated with a spin lock, a semaphore, a read-writer lock, a turnstile, a mutex lock, an adaptive mutex lock, or any other synchronization mechanism.

Application 105 also includes statistics gathering code 10, which gathers statistics relating to usage of mutual exclusion variables 106-107 during execution of application 105. More specifically, statistics gathering code 110 generates statistics on mutual exclusion variable usage 120, as well as a directed call graph 122. Directed call graph 122 includes information specifying how functions call one another during execution of application 105.

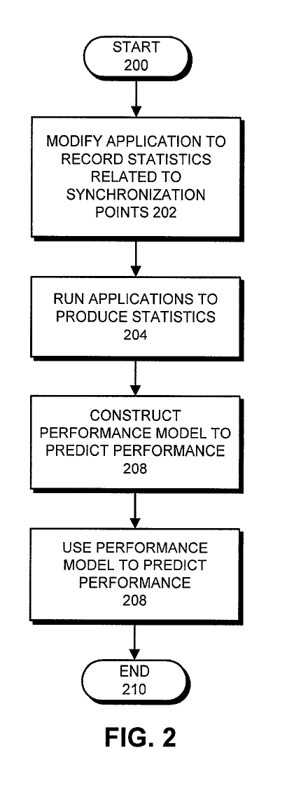

Statistics 120 and directed call graph 122 are combined into a performance model 124, which is used to generate a predicted performance 126 as is described in more detail below with reference to FIGS. 2-4.

Modeling Process

FIG. 2 is a flow chart illustrating the modeling process in accordance with an embodiment of the present invention. The system starts by modifying an application to record statistics related to synchronization points (step 202).

In one embodiment of the present invention, this is accomplished by compiling the application with a profiling option. For example, an application written in the C programming language can be compiled using the command “cc-g appl.c”. The resulting executable code records information relating the execution of the application, such as a sequence of function calls made by the application, a frequency of function calls and elapsed time for each function call. This information can be further processed to isolate information relating so specific function calls that manipulate mutual exclusion variables.

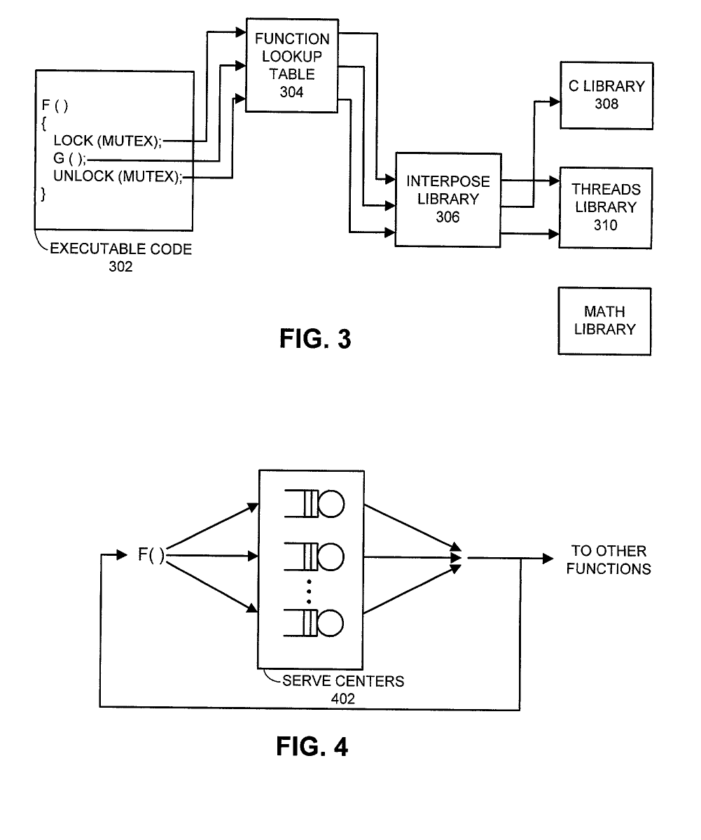

In another embodiment of the present invention, an executable code version of the application is modified to record statistics related to synchronization points. This can be accomplished by using an interposition library as is described below with reference to FIG. 3.

Next, the system runs the application to produce statistics (step 204). As mention above, these statistics can include an identifier for a calling function, an identifier for a mutual exclusion variable, a time spent holding the mutual exclusion variable, and a frequency of accesses to the mutual exclusion variable. This allows the model to take into account the time to execute the code and the number of times the code is executed. For example, a given function f_{( )} may be executed 25 times with a cost of 10 milliseconds per execution. For a shared resource, the parameters of interest are the time spent in the shared resource, and the number of times the shared resource is accessed. These statistics can also include a directed call graph for functions, which describes the order of function calls during execution of the application.

Using these statistics, the system constructs a performance model (step 206), and uses the performance model to predict the performance of the application (step 208). Note that the performance model may be an analytic model that can be numerically solved to predict performance. Alternatively, the performance module can be a simulation module that can be simulated through a computer program to predict the performance.

Interposition Library

FIG. 3 illustrates how an interposition library operates in accordance with an embodiment of the present invention. Executable code 302 makes a number of calls to library functions located outside of executable code 302. These function calls are directed to a function lookup table 304, which normally directs the function calls the functions located within specific libraries, such as C library 308, threads library 310 and math library 312.

In one embodiment of the present invention, an interposition library 306 is inserted between function lookup table 304 and libraries 308, 310 and 312. This is accomplished by modifying function lookup table 304 so that function calls are redirected to interposition library 306. Interposition library 306 then directs the functions call back to the original functions within libraries 308, 310 and 312. However, interposition library 306 additionally contains code that records statistics for functions that manipulate synchronization points (i.e., serialization points in software). For example, interposition library 306 can record the program counter, entry time, exit time and arguments for calls to the lock_{( )} and unlock_{( )} functions for synchronization points.

Performance Model

FIG. 4 illustrates a performance model in accordance with an embodiment of the present invention. In one embodiment of the present invention, each synchronization point is represented by a service center in a queuing system, and each independent process or thread is represented by a job circulating through the queuing system.

In this model, the service time through a service center is determined by empirical measurements of the time between lock_{( )} and unlock_{( )} operations for the corresponding mutual exclusion variable. Furthermore, each function is associated with a set of service centers 402 corresponding to synchronization points manipulated by the function. The frequency with which jobs are directed to specific service centers is determined by the empirical measurements of the frequency of calls by the function to access specific synchronization points.

When a job exits a given function it is directed to other functions in accordance with the directed call graph for the application.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using empirical measurements of accesses to synchronization points within an application to construct a performance model for the application, comprising:
modifying the application to record statistics related to the synchronization points within the application;
running the application to produce the statistics related to synchronization points;
constructing the performance model based upon the statistics; and
using the performance model to predict a performance of the application.

2. The method of claim 1,
wherein constructing the performance model based upon the statistics involves constructing an analytic model for the application; and
wherein using the performance model to predict the performance involves numerically solving the analytic model to predict the performance for the application.

3. The method of claim 1,
wherein constructing the performance model based upon the statistics involves constructing a simulation model for the application; and
wherein using the performance model to predict the performance involves running the simulation model to predict the performance for the application.

4. The method of claim 1, wherein modifying the application involves compiling the application with a profiling option in order to record the statistics related to the synchronization points.

5. The method of claim 1, wherein modifying the application involves modifying the executable code of the application to record the statistics during system calls that operate on the synchronization points.

6. The method of claim 1, wherein the statistics include:
an identifier for a calling function;
an identifier for a mutual exclusion variable;
a time spent holding the mutual exclusion variable; and
a frequency of accesses to the mutual exclusion variable.

7. The method of claim 1, wherein the statistics include a directed call graph specifying an ordering of function calls.

8. The method of claim 7, wherein constructing the performance model involves constructing a queuing model, wherein each synchronization point is a service center for jobs representing processes that circulate between service centers in a manner specified by the directed call graph.

9. A computer-readable storage medium storing instructions that when executed by a computer cause the computer to perform a method for using empirical measurements of accesses to synchronization points within an application to construct a performance model for the application, the method comprising:
modifying the application to record statistics related to the synchronization points within the application;
running the application to produce the statistics related to synchronization points;
constructing the performance model based upon the statistics; and
using the performance model to predict a performance of the application.

10. The computer-readable storage medium of claim 9,
wherein constructing the performance model based upon the statistics involves constructing an analytic model for the application; and
wherein using the performance model to predict the performance involves numerically solving the analytic model to predict the performance for the application.

11. The computer-readable storage medium of claim 9,
wherein constructing the performance model based upon the statistics involves constructing a simulation model for the application; and
wherein using the performance model to predict the performance involves running the simulation model to predict the performance for the application.

12. The computer-readable storage medium of claim 9, wherein modifying the application involves compiling the application with a profiling option in order to record the statistics related to the synchronization points.

13. The computer-readable storage medium of claim 9, wherein modifying the application involves modifying the executable code of the application to record the statistics during system calls that operate on the synchronization points.

14. The computer-readable storage medium of claim 9, wherein the statistics include:
an identifier for a calling function;
an identifier for a mutual exclusion variable;
a time spent holding the mutual exclusion variable; and
a frequency of accesses to the mutual exclusion variable.

15. The computer-readable storage medium of claim 9, wherein the statistics include a directed call graph specifying an ordering of function calls.

16. The computer-readable storage medium of claim 15, wherein constructing the performance model involves constructing a queuing model, wherein each synchronization point is a service center for jobs representing processes that circulate between service centers in a manner specified by the directed call graph.

17. An apparatus for using empirical measurements of accesses to synchronization points within an application to construct a performance model for the application, comprising:
a modification mechanism that is configured to modify the application to record statistics related to the synchronization points within the application;
an execution mechanism that is configured to run the application to produce the statistics related to synchronization points;
a performance model construction mechanism that is configured to construct the performance model based upon the statistics; and
a performance predicting mechanism that is configured to use the performance model to predict a performance of the application.

18. The apparatus of claim 17,
wherein the performance model construction mechanism is configured to construct an analytic model for the application; and
wherein the performance predicting mechanism is configured to predict the performance of the application by numerically solving the analytic model.

19. The apparatus of claim 17,
wherein the performance model construction mechanism is configured to construct a simulation model for the application; and
wherein the performance predicting mechanism is configured to predict the performance of the application by running the simulation model.

20. The apparatus of claim 17, wherein the modification mechanism is configured to compile the application with a profiling option in order to record the statistics related to the synchronization points.

21. The apparatus of claim 17, wherein the modification mechanism is configured to modify the executable code of the application to record the statistics during system calls that operate on the synchronization points.

22. The apparatus of claim 17, wherein the statistics include:
an identifier for a calling function;
an identifier for a mutual exclusion variable;
a time spent holding the mutual exclusion variable; and
a frequency of accesses to the mutual exclusion variable.

23. The apparatus of claim 17, wherein the statistics include a directed call graph specifying an ordering of function calls.

24. The apparatus of claim 23, wherein the performance model construction mechanism is configured to construct a queuing model, wherein each synchronization point is a service center for jobs representing processes that circulate between service centers in a manner specified by the directed call graph.
